(19) United States
(12) Patent Application Publication
(10) Pub. No.: US 2025/0181312 A1
(43) Pub. Date: Jun. 5, 2025

(54) AI-Based Audio Digest System and Related Methods

(71) Applicants: Albert Hernandez, Chino Hills, CA (US); Jonathan Beltran, Chino Hills, CA (US)

(72) Inventors: Albert Hernandez, Chino Hills, CA (US); Jonathan Beltran, Chino Hills, CA (US)

(73) Assignee: IQSpark LLC, Chino Hills, CA (US)

(21) Appl. No.: 19/048,942

(22) Filed: Feb. 9, 2025

(51) Int. Cl. G06F 3/16; G06F 3/01; G06F 21/32; G06F 40/30; G06F 40/58

(52) U.S. Cl. CPC G06F 3/165; G06F 3/011; G06F 3/167; G06F 21/32; G06F 40/30; G06F 40/58

(57) ABSTRACT

The method and system for providing personalized audio content involves processing diverse data from various sources using advanced algorithms to generate engaging audio outputs. The system creates customized audio content relevant to a user's context and preferences, organizes multiple audio clips into a sequence, and allows user interaction with the audio content through voice or touch controls. The system also modifies the content and detail level of the audio digests based on user context, enables automatic task updates based on insights from the audio digests, and provides user-defined privacy settings and voice recognition authentication. The system suggests updates and insights based on user preferences, provides uninterrupted access to audio digests, highlights updates based on sentiment analysis, provides language support and instant translation, and enables interaction with projected visual elements through an AR-based user interface.

### CROSS-REFERENCES

This application claims the benefit of U.S. Provisional Application No. 63/565,531 filed on Mar. 15, 2024, which is incorporated herein by reference in its entirety.

### BACKGROUND OF THE INVENTION

In the modern professional environment, the volume and diversity of communications and updates can be overwhelming. Professionals are expected to stay informed and up-to-date with information from a variety of sources, including emails, project management tools, messaging applications, social media, and other digital platforms. This information often comes in textual format, which can be time-consuming to read and digest. Furthermore, the relevance of the information can vary greatly, making it challenging to prioritize and manage. There is also a need to interact with this information, such as creating action items, sending emails, or searching for prior content. Additionally, the global nature of business today requires support for multiple languages and real-time translation. Security and privacy are also paramount, especially when dealing with sensitive information. Finally, the user experience should be engaging and intuitive, adapting to the user's context and preferences.

### SUMMARY OF THE INVENTION

In accordance with embodiments, a method is provided for delivering personalized audio content. Diverse data from various sources is processed using advanced algorithms to generate engaging audio outputs. Customized audio content is created that is relevant to a user's context and preferences. Multiple audio clips are organized into a sequence based on user preferences. User interaction with the audio content is allowed through voice or touch controls. The content and detail level of the audio digests are modified based on user context. Automatic task updates are enabled based on insights from the audio digests. User-defined privacy settings are provided and users are authenticated through voice recognition.

Updates and insights are suggested based on user preferences. Uninterrupted access to audio digests is provided. Important updates are highlighted based on sentiment analysis. Language support and instant translation are provided. Interaction with projected visual elements is enabled through an AR-based user interface.

In accordance with other embodiments, a system is provided for delivering personalized audio content. The system comprises a data processing unit, a content creation unit, a sequencing unit, a user interaction unit, a content modification unit, a task update unit, a security unit, a recommendation unit, a connectivity unit, a sentiment analysis unit, a language support unit, and an AR interface unit. The data processing unit is configured to process diverse data from various sources using advanced algorithms to generate engaging audio outputs. The content creation unit is configured to create customized audio content that is relevant to a user's context and preferences. The sequencing unit is configured to organize multiple audio clips into a sequence based on user preferences. The user interaction unit is configured to allow user interaction with the audio content through voice or touch controls. The content modification unit is configured to modify content and detail level of the audio digests based on user context. The task update unit is configured to enable automatic task updates based on insights from the audio digests. The security unit is configured to provide user-defined privacy settings and authenticate users through voice recognition. The recommendation unit is configured to suggest updates and insights based on user preferences. The connectivity unit is configured to provide uninterrupted access to audio digests. The sentiment analysis unit is configured to highlight important updates. The language support unit is configured to provide language support and instant translation. The AR interface unit is configured to enable interaction with projected visual elements.

### TECHNICAL FIELD OF THE INVENTION

The invention pertains to the use of advanced AI for transforming diverse textual content into personalized audio clips. It integrates with various digital platforms and project management tools, offering an interactive and context-aware listening experience.

### BRIEF DESCRIPTION OF THE FIGURES

FIG. 1 illustrates, in a flowchart, operations for creating a user-interactive audio digest system in accordance with certain embodiments.

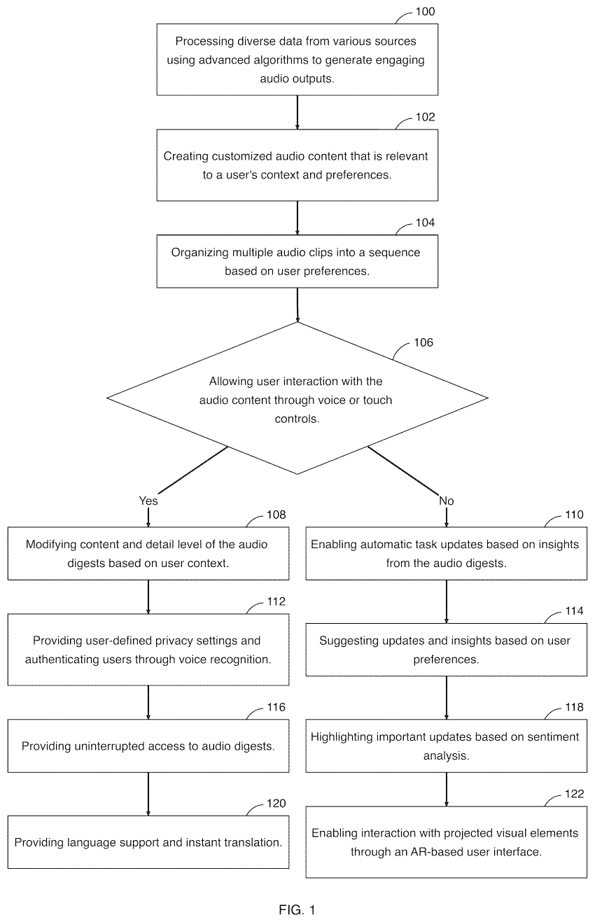

FIG. 1A illustrates, in a flowchart, operations for processing diverse data using advanced algorithms to generate engaging audio outputs.

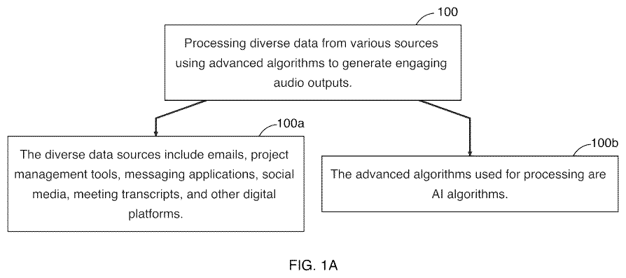

FIG. 1B illustrates, in a flowchart, operations for allowing user interaction with the audio content through voice or touch controls.

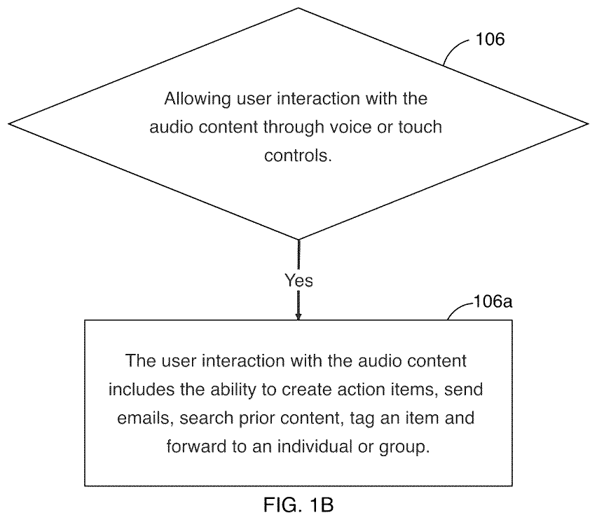

FIG. 1C illustrates, in a flowchart, operations for providing user-defined privacy settings and authenticating users through voice recognition.

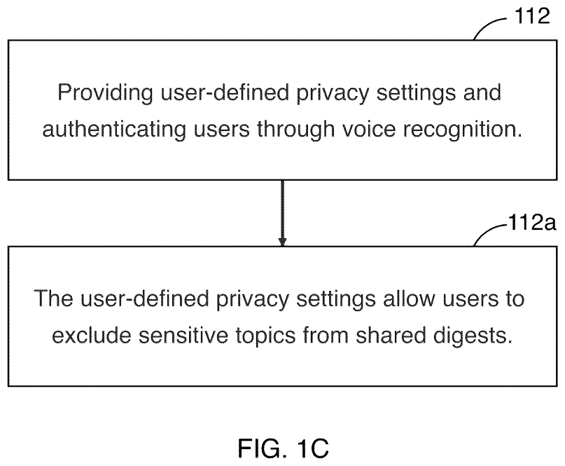

FIG. 1D illustrates, in a flowchart, operations for highlighting important updates based on sentiment analysis.

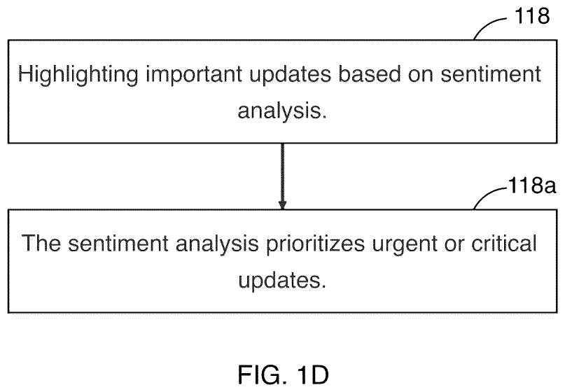

FIG. 1E illustrates, in a flowchart, operations for enabling interaction with projected visual elements through an AR-based user interface.

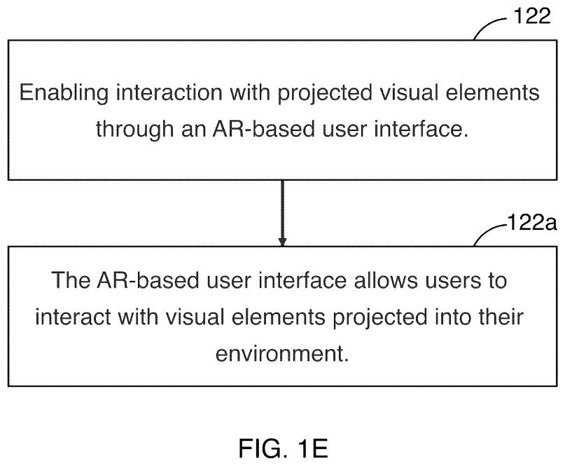

FIG. 2 illustrates, in a block diagram, the components of a Personalized Audio Content Delivery System.

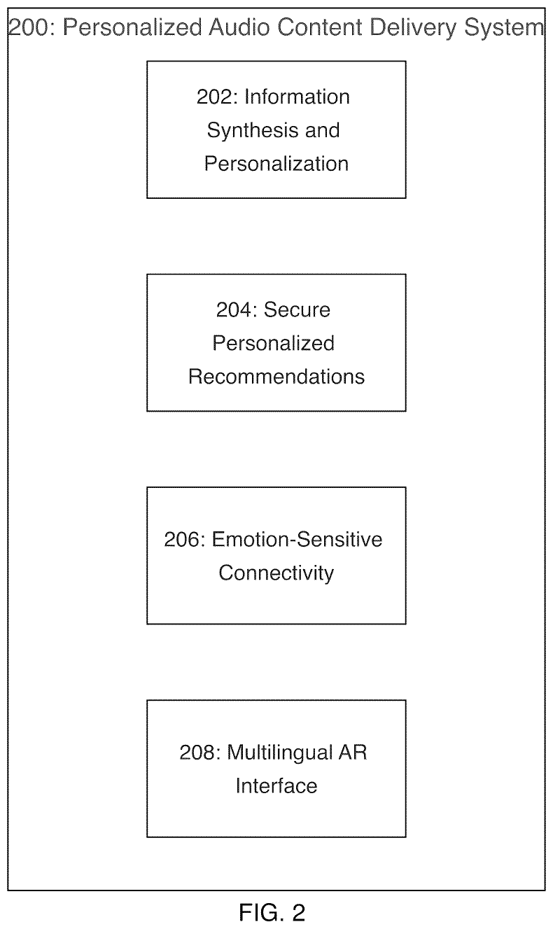

FIG. 2A illustrates, in a block diagram, the sub-components of the ‘Information Synthesis and Personalization’ component.

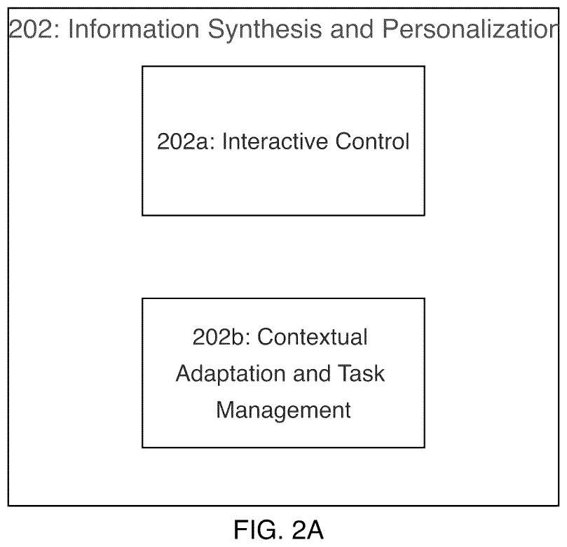

### DETAILED DESCRIPTION

Step 100 involves the processing of data from a variety of sources using algorithms to generate audio outputs. This step is foundational, as it converts raw data into a consumable audio format for users.

The actions within this step include:

1. Data processed: This action involves collecting and aggregating data from multiple sources such as emails, project management tools, messaging applications, social media, meeting transcripts, and other digital platforms (Step 100-a). The objective is to gather a broad range of information that may be relevant to the user.

2. Algorithms used for processing: The data collected is processed using AI algorithms (Step 100-b). These algorithms are designed to understand context, extract key information, and learn from user interactions and schedules to tailor the content to the user's preferences.

3. Audio outputs generated: The processed data is transformed into audio clips using text-to-speech technology. This involves converting text into speech in a manner that is engaging and comprehensible for the user. The tools involved scan the sources, summarize the information, and create audio clips that are personalized to the user's context and preferences.

The components involved in this step are the data sources, the AI algorithms, and the audio output generation tools. The data sources provide the raw material, the AI algorithms act as the processor that interprets and refines the data, and the audio output generation tools are the means by which the processed data is delivered to the user audibly.

The objective of these actions is to ensure that users receive a listening experience that allows them to stay informed efficiently. By processing data from various sources with AI algorithms, the system can generate audio outputs that are not only engaging but also tailored to the specific needs and preferences of each user. This step sets the stage for subsequent features of the system, such as customization, user interaction, and content modification.

Step 102 involves the generation of audio content tailored to the user's specific context and preferences. This process utilizes AI algorithms (Step 100-b) to analyze and interpret data (Step 100) sourced from emails, project management tools, messaging applications, social media, meeting transcripts, and other digital platforms (Step 100-a). The AI algorithms are programmed to recognize patterns in user interactions and schedules, which allows them to determine the relevance of content for each individual user.

The transformation of the collected data into audio clips is executed by AI, which not only summarizes the information but also adapts it to fit the user's expressed interests and needs. For instance, if a user frequently engages with updates about a particular project, the AI will give priority to similar content in the audio digest it compiles for that user.

The objective of Step 102 is to provide an audio experience that is tailored to the user, aiming to make the process of staying informed efficient and tailored to the user's schedule. By delivering content that is relevant and timed according to the user's context, Step 102 seeks to streamline the user's workflow and enhance productivity.

In essence, Step 102's process of generating customized audio content involves AI algorithms that process and synthesize data from a range of digital sources. These algorithms utilize the user's behavior and preferences to produce audio clips that are personalized and relevant, ensuring that the content delivered is both engaging and useful to the user.

Step 104 involves the organization of audio clips into a sequence that aligns with user preferences. This step is executed by AI algorithms that analyze user behavior and preferences to determine an appropriate order for the audio clips. The AI system considers user interaction history, preferences, and possibly contextual information such as time of day or user schedule to create a sequence that is relevant and timely.

The AI algorithms are tasked with learning from user interactions to create a sequence that feels intuitive to the user. For instance, if a user regularly listens to updates from a specific project early in the day, the AI would arrange audio clips related to that project accordingly. If the user has marked certain updates as a priority, the AI would ensure these are positioned prominently within the sequence.

The goal of this step is to make the process of consuming information more efficient and tailored to the user's needs. By arranging the audio clips in a personalized sequence, the system aims to present the user with relevant information when it is likely to be most useful, enhancing the user experience and potentially improving productivity.

The parameters for this step would likely include the user's historical data, any preferences set by the user, the content and urgency of the audio clips, and contextual information such as the user's current activity or location.

In summary, Step 104's process of arranging audio clips is a complex task that involves analyzing user data and preferences to present audio content in a manner that aligns with the user's habits and needs. This process is central to delivering a personalized and engaging listening experience.

Step 106 involves enabling user interaction with audio content through voice or touch controls. This step is realized through the development of a user interface within the audio content delivery system that recognizes and processes user inputs. Users engage with the audio content by issuing voice commands or employing touch gestures, which the system's interface interprets and executes as specific functions.

Sub-step 106-a expands on this by detailing the types of functions a user can perform. These functions include creating reminders or tasks, composing and sending emails, conducting searches within the delivered audio content, tagging audio clips for later reference, and sharing information by forwarding it to others.

The interface is engineered to comprehend specific voice commands and touch gestures, converting these user inputs into executable actions. For instance, when a user vocalizes a command to initiate a search, the interface processes this input and performs the search within the content. Similarly, if a user taps a certain area of the touch interface to tag an audio clip, the system acknowledges this gesture and tags the clip accordingly.

The design of the interface is such that it can integrate with other applications to facilitate these actions directly from within the audio content interface. This integration allows users to perform tasks associated with the audio content without the need to switch contexts or devices.

The explanation aims to provide a clear understanding of how users can interact with the audio content and the capabilities of the system to recognize and carry out user commands. This includes the mechanisms for processing voice and touch inputs, the structure of the interface that enables such interactions, and the parameters that define the scope of interactions, such as the range of supported voice commands and touch gestures.

Step 108 involves adjusting the content and detail level of audio digests to align with the user's current situation. This step requires the system to analyze contextual data, which may include the user's location, time, current activity, and expressed preferences. The system's content modification unit processes this data to tailor the audio digests, which could involve changing the amount of detail, reordering information, or emphasizing certain parts.

The purpose of this step is to deliver information in a manner that suits the user's immediate circumstances. For instance, if a user is engaged in an activity that allows for minimal distraction, the system might provide summaries that are more succinct. On the other hand, if the user is in a setting where they can devote more attention to the content, the system might offer more comprehensive digests.

This step is executed by the system's algorithms that learn from user interactions and preferences over time. These algorithms use the user's context and preferences to modify the audio content. The process is automated and occurs without user intervention, aiming to provide a seamless experience.

Parameters for this step include the user's historical data, real-time context signals, and any user-defined settings. The algorithms process these parameters to determine the optimal structure and detail for the audio content at any given time. This ensures that the audio digests are adapted to the user's current context, enhancing the relevance and accessibility of the information provided.

Step 110 involves the system's capability to update tasks within project management tools automatically, based on the content extracted from audio digests. This step is essential for keeping project statuses up to date by reflecting the latest insights derived from the audio content, thereby aiding in efficient project management.

### Actions for Step 110:

**Task Updates**: This action refers to the system's ability to update tasks within project management tools. The task update unit interacts with project management tools to reflect changes or new information that has been identified within the audio digests. The purpose of this action is to reduce the need for manual entry and ensure that tasks are current, reflecting the insights from the audio content.
**Integration with Project Management Tools**: This action involves the system's connection with various project management platforms. The task update unit and the project management tools work together to facilitate the automatic updating of tasks. This integration is done to maintain an up-to-date workflow that aligns with the information provided in the audio digests.

The system identifies actionable items or insights within the audio digests that can translate into task updates. For example, if an audio digest mentions a change in a deadline or a new task assignment, the system will automatically update these details in the corresponding project management tool.

This process requires AI algorithms (Step 100-b) capable of interpreting the context and content of audio digests. These algorithms recognize specific cues or keywords that indicate a need for task updates. Once these updates are identified, they are communicated to the project management tools, ensuring that the user's task lists are synchronized with the latest information without manual intervention.

Step 110 reflects the system's ability to manage tasks proactively, based on the user's interactions and schedules. By providing relevant audio content and managing tasks, the system enhances the efficiency of the user's workflow.

In summary, Step 110 is an interaction between AI algorithms, audio content, and project management tools, designed to automate the updating of tasks based on insights from personalized audio digests. This step exemplifies the system's functionality as an assistant, reducing the manual workload on users and allowing them to focus on strategic activities.

Step 112 involves the provision of privacy settings that users can define themselves within the audio content platform. This mechanism allows users to specify which topics or information they wish to keep confidential and prevent from being included in audio digests that might be shared or accessed by others. Users interact with the system to set their privacy preferences to maintain control over the dissemination of certain information.

Sub-step 112-a specifies that these privacy settings enable users to exclude particular topics from shared digests. The system provides an interface for users to label certain topics or keywords as sensitive, and it then filters or redacts this content from the audio digests accordingly. The purpose of this functionality is to uphold the privacy of information as determined by the user.

Additionally, Step 112 includes the process of user authentication through voice recognition. This involves capturing a user's voice and analyzing its unique characteristics to verify identity before allowing access to certain features of the platform. Users submit a voice sample, which the system compares to a stored voiceprint for identity confirmation. This procedure is implemented to prevent unauthorized access and ensure that only verified users can interact with secure aspects of the platform.

Both functions in Step 112 and sub-step 112-a are designed to safeguard user privacy and secure access to the personalized audio content, maintaining user trust and confidentiality within the system.

Step 114 involves the system analyzing user interactions and learned preferences to recommend updates and insights. The system utilizes collaborative filtering, which processes large volumes of data to identify patterns that can be used to suggest content that users with similar profiles have found engaging. This step is designed to tailor the audio content to the specific interests and needs of the user.

The recommendations are made based on the user's past interactions, such as listening habits and feedback on audio clips, as well as any preferences set within the user profile. These preferences might include topics of interest, preferred sources of information, frequency of updates on certain topics, and the level of detail desired.

The system compares the user's profile against a dataset containing profiles of numerous users to find those with similar preferences. By doing so, the system can suggest new content that aligns with the user's interests, potentially introducing them to updates and insights they have not yet encountered.

The outcome of Step 114 is that the user receives audio digests that are aligned with their interests and preferences, which aims to save time and make the process of staying informed more efficient.

Step 116 involves the provision of continuous access to audio digests without the need for an active internet connection. This step is implemented through a feature that allows audio content to be stored on the user's device. The mechanism behind this feature is predictive caching, where the system anticipates which audio clips a user is likely to need next and downloads them when the device has internet access. This ensures that the user has a selection of audio content available even when they are offline.

The components involved in this step include a data processing module, a connectivity module, and the user's device. The data processing module determines which audio clips to cache by analyzing the user's listening habits and preferences. The connectivity module manages the download of these clips when the device is online. The user's device is responsible for storing the cached audio clips and providing them to the user upon request, irrespective of internet connectivity.

The objective of this step is to maintain a seamless flow of information to the user, which is beneficial for users who may experience unstable internet connections or who are frequently on the move. By enabling access to audio content at any time, Step 116 enhances the usability of the system, making it a dependable tool for users to remain informed and efficient in their tasks.

Step 118 involves the process of sentiment analysis within a system designed to deliver personalized audio content. Sentiment analysis refers to the application of natural language processing (NLP), text analysis, and computational linguistics to identify, extract, quantify, and study affective states and subjective information from textual data. In the context of Step 118, this process is applied to data sources such as emails, project management tools, messaging applications, social media, meeting transcripts, and other digital platforms (Step 100-a).

The components involved in Step 118 include a sentiment analysis module and the source materials containing text. The sentiment analysis module performs the function of analyzing the emotional tone of the source materials to determine the urgency of updates (Step 118-a). This function helps prioritize which updates should be highlighted in the audio digests, ensuring that users receive updates in an order that reflects their urgency.

The sentiment analysis module uses algorithms to assess the emotional tone of text. These algorithms are trained to detect language nuances that may indicate urgency, such as words expressing concern, deadlines, or phrases suggesting that action is required. The output of this analysis is then used to order audio clips, so that updates with a higher urgency are presented to the user first.

The process involves parsing text, identifying phrases that carry sentiment, and classifying the sentiment of each phrase or the overall message. The classification could be binary (positive/negative), a scale, or even multi-dimensional (capturing various emotions). The result of this analysis influences the ordering of audio clips (Step 104), ensuring that updates with a higher urgency are delivered to the user promptly.

In summary, Step 118 and sub-step 118-a describe the function of performing sentiment analysis on textual data to order audio content for the user. This involves algorithms that analyze the emotional tone of the source materials to highlight updates based on their urgency, thereby enhancing the relevance and timeliness of the audio digests provided to the user.

Step 120 involves the provision of language support and instant translation for the audio content generated by the system. This step is necessary for users to listen to digests in their preferred language, enhancing accessibility and usability.

In Step 120, language processing algorithms detect the language of the input text, which could be from emails, project management tools, messaging applications, social media, meeting transcripts, or other digital platforms as mentioned in Step 100-a. Following language identification, translation algorithms translate the text into the user's selected language. This process is conducted while preserving the context and meaning of the original content to ensure that the translated audio remains relevant.

The rationale for these processes is to enable users from different linguistic backgrounds to access and understand the audio digests without language barriers, making the content more inclusive and personalized.

The goal of defining this process is to explain how the system can support multiple languages and provide instant translation, which is a key feature for a platform serving users worldwide. The parameters for this process include the list of supported languages, the accuracy of the translation, and the speed at which the translation is performed. The mechanism involves the use of algorithms capable of natural language understanding and machine translation, as referenced in Step 100-b.

In summary, Step 120's process of providing language support and instant translation involves language detection, machine translation, and the integration of these technologies into the system to produce audio content that is accessible to a diverse user base.

Step 122 involves the use of an Augmented Reality (AR) interface that facilitates user interaction with visual elements that appear within their physical environment. This AR interface comprises both hardware and software components. The hardware is responsible for capturing the user's surroundings and detecting their movements and gestures. The software processes this input to overlay digital visual elements onto the user's view of the real world. These visual elements are contextually relevant to the audio content being presented and are designed for intuitive interaction.

Users engage with these visual elements through gestures or voice commands. The system interprets these inputs to perform various functions, such as navigating between audio clips or accessing additional information. The objective is to provide a seamless experience that enhances user engagement with audio content by allowing for natural interactions within their environment.

In practice, step 122 would manifest as a user wearing AR glasses or using an AR-enabled device, which displays virtual controls and information as part of their surroundings. For example, a user could point to a virtual button to initiate playback of an audio clip or swipe to transition to the next piece of content. The system recognizes these gestures and responds by executing the corresponding actions, offering an interactive audio-visual experience tailored to the user's context and preferences.

Sub-step 122-a specifies that the AR interface allows users to interact with visual elements projected into their environment. This sub-step details the mechanism by which the AR interface enables users to engage with the audio content in a manner that is integrated with their physical space, thereby providing an enriched experience that goes beyond traditional audio playback.

The Personalized Audio Content Delivery System (200) is designed to convert textual data into customized audio digests. This system includes several components that work together to facilitate this process.

The Information Synthesis and Personalization component (202) collects data from various digital platforms, including emails, project management tools, messaging applications, social media, and meeting transcripts. Advanced AI algorithms within this component process the collected data by parsing the text, identifying key information, and converting this information into audio formats. The output is tailored to the user's preferences and context, ensuring that the audio content is relevant and personalized.

The Interactive Control sub-component (202-a) provides a mechanism for users to interact with the audio content. This interaction is made possible through voice or touch controls, which allow users to navigate the content, create action items, send emails, and search or tag content for later use. This functionality is designed to facilitate user engagement with the content in a convenient manner.

The Contextual Adaptation and Task Management sub-component (202-b) is responsible for adjusting the content based on the user's situation, such as their location or time of day. It also integrates with project management tools to automatically update tasks based on the insights gained from the audio digests. This integration ensures that the system not only provides information but also assists in managing the user's tasks effectively.

These components and sub-components of the system (200) operate in unison to deliver an audio experience that is personalized and adapts to the user's context, thereby enhancing the efficiency of information consumption and task management.

The Information Synthesis and Personalization component (202) plays a key role in the system by processing data from various digital sources to create audio content that aligns with user preferences. This component utilizes advanced AI algorithms to transform textual information from emails, project management tools, messaging applications, social media, and meeting transcripts into audio formats. The transformation process is designed to ensure that the content is presented in an audio format that is suitable for the user, focusing on delivering the essential information in a concise manner.

Within this component, the Interactive Control sub-component (202-a) provides a mechanism for users to interact with the audio content. It recognizes and processes inputs, whether they are voice commands or touch gestures, enabling users to navigate through audio clips, manage tasks, and communicate with others directly through the audio interface. This sub-component is responsible for allowing users to engage with the content in a manner that suits their needs, facilitating a more efficient interaction with the system.

The Contextual Adaptation and Task Management sub-component (202-b) is responsible for customizing the audio content based on the user's context. It analyzes the user's schedule, location, and preferences to determine the timing and level of detail for the audio digests. This sub-component also has the capability to interface with project management tools, providing the functionality to update tasks automatically based on the insights from the audio content. The integration of these sub-components ensures that the system delivers audio content that is personalized and relevant to the user's current situation, thereby supporting an efficient workflow and information management.

The Secure Personalized Recommendations component, numbered 204, is integral to the audio content delivery system, focusing on user-specific content delivery while maintaining security and privacy. This component includes sub-components such as Collaborative Filtering, numbered 204-a, which utilizes user data to tailor content recommendations. It analyzes user interactions and preferences to curate relevant audio digests, refining its suggestions through continuous learning from user feedback and similar profiles.

In parallel, Voice Biometrics, sub-component 204-b, employs voice recognition algorithms for user authentication. This sub-component is responsible for ensuring that access to personalized content is secure and that sensitive information is protected from unauthorized access. It is particularly vital when the system updates tasks or shares insights based on audio digests, as it relies on the integrity of user data and the enforcement of privacy settings.

The operation of component 204 within the system is characterized by the collaboration between its sub-components. Collaborative Filtering personalizes the content, while Voice Biometrics secures the delivery to the authenticated user. This ensures that the system provides a secure user experience by delivering personalized content recommendations and maintaining the confidentiality of user interactions.

The Emotion-Sensitive Connectivity component (206) plays a role in analyzing sentiments and ensuring access to audio digests. This component includes a sentiment analysis unit (206-a) that evaluates the emotional tone of source materials, and a predictive caching unit (206-b) that facilitates offline access to content.

The sentiment analysis unit (206-a) processes textual data to determine the urgency of updates. It uses natural language processing and machine learning to analyze the content from various sources, such as emails and social media. The unit identifies updates with a significant emotional tone and prioritizes them in the audio digest sequence. This process ensures that users receive timely notifications of updates that may require immediate attention.

The predictive caching unit (206-b) works to provide continuous access to audio digests, even without an active internet connection. It predicts the user's information needs based on historical usage patterns and preloads relevant content onto the device. This feature is particularly useful in situations where users may experience intermittent connectivity, allowing them to stay informed with the latest updates.

These sub-components of (206) operate together to deliver audio digests that are not only relevant to the user's context but also reflect the sentiment of the source material, while maintaining accessibility in various connectivity scenarios.

The Multilingual AR Interface (208) serves as a key component in the personalized audio content delivery system, focusing on language translation and augmented reality interaction. This component is designed to deliver audio content in multiple languages, catering to a diverse user base. It achieves this through a real-time translation feature that converts audio content into the user's chosen language, ensuring accessibility and comprehension.

The AR Interface aspect of this component provides a method for users to interact with audio content in an immersive manner. By projecting visual elements into the user's environment, the system allows for a more engaging experience. Users can interact with these elements to navigate audio digests, create action items, or search through content. This interaction is facilitated through voice commands or touch gestures, depending on the user's preference and the context of use.

The combination of language support and AR interface in component (208) addresses the need for a system that is both adaptable to various languages and capable of providing an interactive experience. The system employs algorithms and AI to process audio content and user interactions, ensuring that the functionality is responsive to the user's context. This component is integrated into the overall system to enhance the delivery and interaction with personalized audio content.

1. A system for generating personalized audio digests, comprising:
a data processing unit configured to collect and process textual data from multiple sources, including emails, project management tools, social media, and messaging applications;
a content creation unit that synthesizes the processed data into structured audio outputs using AI-based summarization and text-to-speech technologies;
a sequencing unit that organizes and prioritizes audio clips based on user preferences, contextual relevance, and sentiment analysis;
a user interaction unit that enables voice and touch-based interactions, allowing users to control playback, navigate between audio digests, and execute related actions;
a content modification unit that dynamically adjusts the level of detail and structure of the audio digests based on user activity, time, and location;
a task update unit that integrates with project management tools to create, modify, and update tasks based on the extracted insights from audio digests;
a security unit that provides user authentication via voice biometrics and configurable privacy controls to restrict access to sensitive content;
a recommendation unit employing machine learning algorithms to suggest relevant content, insights, or follow-up actions;
a connectivity unit with predictive caching to enable offline access to audio digests;
a sentiment analysis unit that determines urgency and emotional tone of content to prioritize delivery;
a language support unit that offers real-time translation and multilingual audio synthesis; and
an augmented reality (AR) interface unit that projects interactive visual elements, enabling gesture and voice-based user engagement.

2. A method for delivering personalized audio content, comprising:
collecting textual data from multiple sources;
processing the data using AI algorithms to extract key information and summarize content;
generating an audio digest based on user preferences and context;
organizing audio clips into a structured sequence based on relevance, urgency, and sentiment analysis;
allowing user interaction with audio content through voice and touch commands;
modifying content dynamically based on user location, schedule, and preferences;
updating project management tools with actionable insights derived from audio digests;
securing access via voice authentication and privacy settings;
suggesting content and follow-ups using machine learning models;
ensuring offline access to digests via predictive caching;
translating content into multiple languages in real-time; and
enabling AR-based visual interaction for enhanced engagement.

3. The system of claim 1, wherein the data processing unit applies natural language processing (NLP) to identify key topics, entities, and action items from input text.

4. The system of claim 1, wherein the content creation unit uses deep learning-based text-to-speech models to generate human-like synthesized voice outputs.

5. The system of claim 1, wherein the sequencing unit prioritizes content based on historical user behavior, contextual activity, and explicit preferences.

6. The system of claim 1, wherein the user interaction unit enables speech-to-text functionality for users to dictate notes, responses, or commands.

7. The system of claim 1, wherein the content modification unit personalizes audio length and depth by assessing available user engagement time.

8. The system of claim 1, wherein the task update unit integrates with third-party productivity tools such as Trello, Asana, Jira, and Microsoft Teams.

9. The system of claim 1, wherein the security unit employs multi-factor authentication for enhanced data protection.

10. The system of claim 1, wherein the recommendation unit utilizes collaborative filtering to improve content suggestions based on user cohorts with similar preferences.

11. The system of claim 1, wherein the connectivity unit pre-loads audio clips based on anticipated user needs using AI-driven predictions.

12. The system of claim 1, wherein the sentiment analysis unit classifies content urgency levels as low, medium, or high priority based on emotional indicators.

13. The system of claim 1, wherein the language support unit uses neural machine translation to ensure contextually accurate multilingual support.

14. The system of claim 1, wherein the AR interface unit projects interactive transcription overlays, enabling real-time annotation and navigation.

15. The system of claim 1, wherein the audio digests are delivered through smart speakers, mobile applications, wearable devices, and vehicle infotainment systems.

16. The system of claim 1, wherein the AI-based summarization dynamically adjusts verbosity based on detected user fatigue or interaction frequency.

17. The system of claim 1, wherein the content prioritization model is adaptive, continuously learning from feedback signals such as skipped content, replay frequency, or explicit ratings.

18. The system of claim 1, wherein the system can operate in an edge-computing mode to generate and store digests locally without requiring cloud processing.

19. The system of claim 1, wherein blockchain-based encryption is used to enhance privacy and secure content integrity.

20. The system of claim 1, wherein audiovisual augmented intelligence integrates AI-generated content with real-time data feeds for decision support.

21. The system of claim 1, wherein the content creation unit enables user-customizable audio preferences, allowing selection of voice characteristics including accent, tone, pitch, speaking rate, gender, and emotional expressiveness to personalize the listening experience.
